(19) United States
(12) Patent Application Publication
(10) Pub. No.: US 2010/0215850 A1
(43) Pub. Date: Aug. 26, 2010

(54) METHOD OF MANUFACTURING AN ADHESIVE MATERIAL THAT CAN BE PRINTED AND REPEATEDLY STUCK AND TORN

(76) Inventor: Lung-Wen CHOU, Longjing Township (TW)

Correspondence Address: SINORICA, LLC, 2275 Research Blvd., Suite 500, ROCKVILLE, MD, 20850, US

(21) Appl. No.: 12/389,404

(22) Filed: Feb. 20, 2009

(51) Int. Cl. B05D 5/10

(52) U.S. Cl. 427/207.1

(57) ABSTRACT

A method of manufacturing an adhesive material that can be printed and repeatedly stuck and torn including a first mixing step in which a first material of isocyanate polymer containing NCO is mixed with a second material of hydroxy compound containing OH into a first mixture; a first coating step in which the first mixture is coated on a substrate to form an adhesive layer; a second mixing step in which at least the first material, the second material, and a fiber material are mixed into a second mixture, and a second coating step in which the second mixture is coated on the adhesive layer to form a printing layer, a finished product being formed. A pattern or character can be printed on the printing layer, and the printing layer is pasted on a determined site for repeated paste and tear. The product is preferably resilient and not easily damaged.

### BACKGROUND OF THE INVENTION

1. Field of the Invention

This invention relates to a method of manufacturing an adhesive material that can be printed and repeatedly stuck and torn.

2. Description of the Related Art

As an adhesive material used for a conventional advertisement label, a paper is used mostly for inscribe or printing and coated with viscose or glue to be fixed onto a determined site. However, if being exposed to the wind and the rain for a long time, the paper will be damaged, thereby the effect of paste being not achieved.

Besides, the viscose used for the paper can be used only one time, so the paper cannot be stuck and torn repeatedly for achievement of the effect of many times of usage. Thus, improvement is necessarily made.

Consequently, because of the technical defects of described above, the applicant keeps on carving unflaggingly through wholehearted experience and research to develop the present invention, which can effectively improve the defects described above.

### SUMMARY OF THE INVENTION

A method of manufacturing an adhesive material that can be printed and repeatedly stuck and torn according to this invention comprising a first mixing step in which a first material of isocyanate polymer containing NCO is mixed with a second material of hydroxy compound containing an OH into a first mixture; a first coating step in which the first mixture is coated on a substrate to form an adhesive layer; a second mixing step in which at least the first material, the second material, and a fiber material are mixed into a second mixture, and a second coating step in which the second mixture is coated on the adhesive layer to form a printing layer, thereby a finished product being formed.

Thus, a pattern or character can be printed on the printing layer, and the printing layer is pasted on a determined site by using the adhesive layer for achievement of repeated paste and tear. Further, part of the second mixture is of TPU, so the product is preferably resilient and not easily damaged due to climate change.

### BRIEF DESCRIPTION OF THE DRAWINGS

FIG. 1 is a flow chart of a method of manufacturing an adhesive material according to this invention;

FIG. 2 is a schematic view illustrating of the method of manufacturing the adhesive material according to this invention;

FIG. 3 is an enlarged view of the adhesive material according to this invention; and

FIG. 4 is a view of the adhesive material according to this invention under use.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

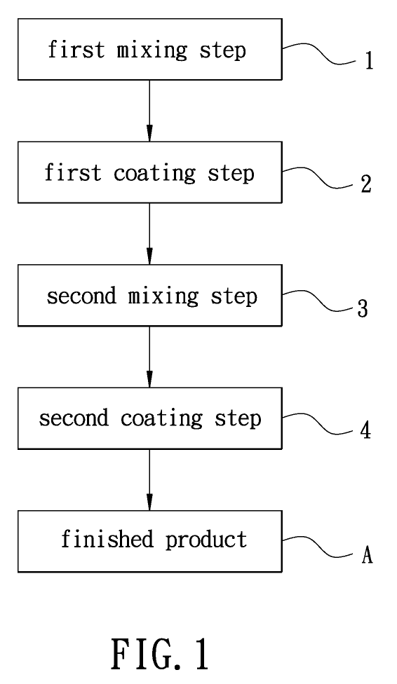

Firstly, with reference to FIG. 1 shown as a flow chart of a method of manufacturing an adhesive material according to this invention, the method comprises a first mixing step 1, a first coating step 2, a second mixing step 3, and a second coating step 4.

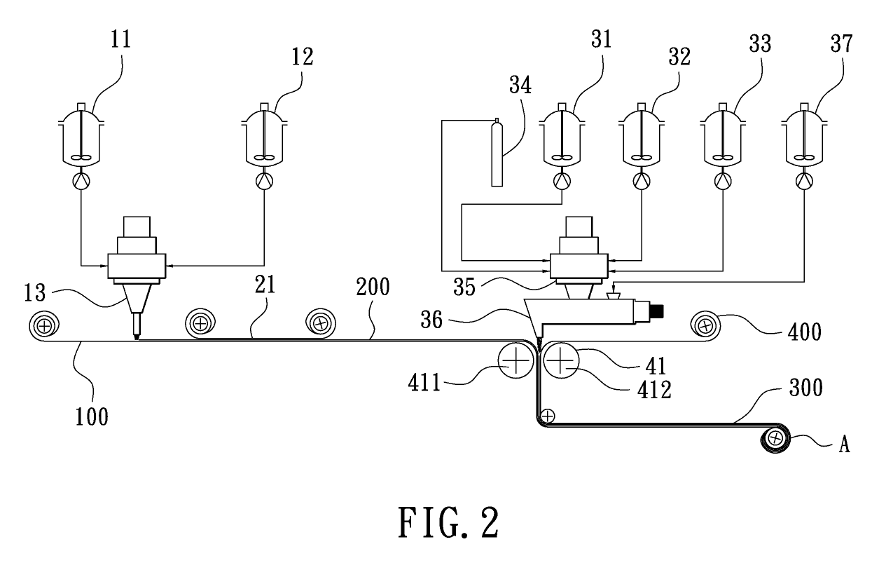

With simultaneous reference to FIG. 2 shown as a schematic view illustrating of the method of manufacturing the adhesive material according to this invention, the steps are described in detail below.

In the first mixing step 1, a first material of isocyanate polymer containing NCO and a second material of hydroxy compound containing an OH are separately arranged in a first metric output device 11 and a second metric output device 12; the first metric output device 11 and the second metric output device 12 are linked with a first injection material mixing device 13 to make the first material and the second material to be injected into the first injection material mixing device 13 and then evenly stirred and mixed into the first mixture; the first mixture is a material of TPU (Thermoplastic Polyurethane).

In the first coating step 2, the first mixture falls of itself into the surface of a substrate 100 from the first injection material mixing device 13 and, following the substrate 100 that rolls, spreads all over the surface of substrate 100, and an adhesive layer 200 is formed; in a preferred embodiment of this invention, the substrate 100 is a release paper; further, a release paper 21 is pasted on the surface of adhesive layer 200 so as to make the surface of adhesive layer 200 to be more flat, behind which the release paper 21 is rolled out of a determined site.

In the second mixing step 3, the first material, the second material, a coloring material, and a bubbling material are separately arranged in a third metric output device 31, a fourth metric output device 32, a fifth metric output device 33, and a sixth metric output device 34; the third metric output device 31, the fourth metric output device 32, the fifth metric output device 33, and the sixth metric output device 34 are further linked with a second injection mixing device 35 to make the first material, the second material, the coloring material, and the bubbling material to be together injected into the second injection material mixing device 35, stirred and mixed, and further injected into a kneading device 36; the kneading device 36 is further linked with a seventh metric output device 37; a fiber material is filled in the seventh metric output device 37; in the preferred embodiment of this invention, the fiber material is paper powder; besides, the kneading device 36 evenly stir and mix the first material, the second material, the coloring material, the bubbling material, and the fiber material into a second mixture.

In the second coating step 4, the second mixture flows out of the inside of kneading device 36 and forms a coat on the adhesive layer 200, and a printing layer 300 is formed; besides, a pressing device 41 is matched to press the second mixture for a determined form and thickness; the pressing device 41 is arranged under the kneading device 36 and comprises a first roller 411 and a second roller 412 that are parallel with each other and are kept at a distance of interval, in which the first roller 411 can roll the substrate 100 coated with the adhesive layer 200 and the second roller 412 rolls a protective material 400, and the substrate 100 and the protective material 400 are made to shifts towards the first roller 411 and the second roller 412 at the same time; the printing layer 300 is formed between the adhesive layer 200 and the protective material 400 to form a finished product A; in the preferred embodiment of this invention, the protective material 400 is a plastic film made from a PE material; besides, the finished product A is rolled up.

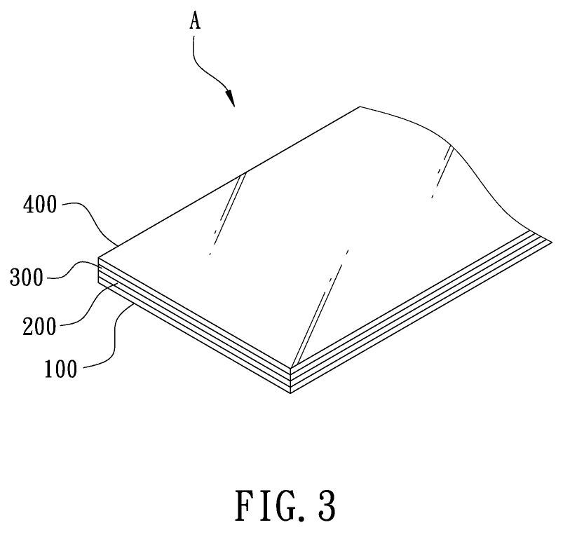

With reference to FIG. 3 shown as an enlarged view of the adhesive material according to this invention, the finished product A, from bottom to top, comprises the substrate 100, the adhesive layer 200, the printing layer 300, and the protective material 400. The substrate 100, the adhesive layer 200, the printing layer 300, and the protective material 400 are evenly fine and combined in one.

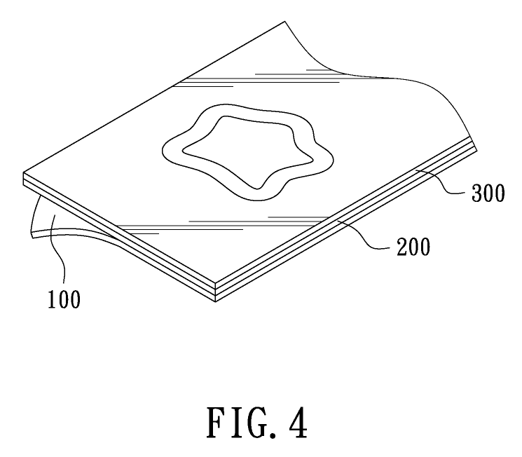

With reference to FIG. 4 shown as the adhesive material according to this invention under use, with the protective material 400, the surface of printing layer 300 can be protected, which thus avoids the surface of printing layer 300 from being scratched and the printing layer 300 from being stained with foreign matters. Thus, when the protective material 400 is torn down, a character or pattern can be laid on the surface of printing layer 300 by means of inscribe or printing. The printing layer 300 is made from the first material of isocyanate polymer containing NCO and the second material of hydroxy compound containing OH that are mixed, so the printing layer 300 is more resilient than a general paper. The fiber material can also absorb ink during printing or inscribe so as to make the pattern or character not easily haze or blur. Further, the substrate 100 is torn down from the adhesive layer 200 and one side of the adhesive layer 200 is pasted on a determined site for achievement of the effect of promotion and bulletin that lasts longer than a general paper, and the effect of repeated paste and tear.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method of manufacturing an adhesive material to be printed and repeatedly stuck and torn comprising:
a first mixing step in which a first material of isocyanate polymer containing NCO and a second material of hydroxy compound containing OH are mixed into a first mixture;
a first coating step in which the first mixture is coated on a substrate to form an adhesive layer;
a second mixing step in which at least the first material, the second material, and a fiber material are mixed into a second mixture; and
a second coating step in which the second mixture is coated on the adhesive layer to form a printing layer, thereby a finished product being formed;
the first material and the second material are separately arranged in a first metric output device and a second metric output device in the first mixing step; and
the first metric output device and the second metric output device are linked with a first injection material mixing device to make the first material and the second material to be injected into the first injection material mixing device wherein the first material and the second material are evenly stirred and mixed into the first mixture;
in the first coating step, the first mixture is arranged in a first injection material mixing device;
the first mixture falls of itself onto the surface of a substrate from the first injection material mixing device and, following the substrate being rolled continuously by rollers, the first mixture spreads all over the surface of the substrate, thereby an adhesive layer being formed;
in the second mixing step, the first material, the second material, a coloring material, and a bubbling material that forms bubbles are separately arranged in a third metric output device, a fourth metric output device, a fifth metric output device, and a sixth metric output device;
the third metric output device, the fourth metric output device, the fifth metric output device, and the sixth metric output device are linked with a second injection mixing device;
the first material, the second material, the coloring material, and the bubbling material are together injected into the second injection material mixing device, stirred and mixed, and further injected into a kneading device;
the kneading device is linked with a seventh metric output device;
the fiber material is filled in the seventh metric output device, and the kneading device evenly stirs and mixes with the first material, the second material, the coloring material, the bubbling material, and the fiber material into a second mixture;
in the second coating step, the second mixture flows out of the kneading device and forms a coating on the adhesive layer wherein a printing layer is formed;
a pressing device presses the second mixture for a determined form and thickness;
the pressing device is arranged under the kneading device and comprises a first roller and a second roller that are parallel with each other and are kept at a distance of interval;
the first roller rolls the substrate coated with the adhesive layer and the second roller rolls a protective material; and
the substrate and the protective material are made to shift towards the first roller and the second roller at the same time, and are transmitted downwards, and the printing layer is formed between the adhesive layer and the protective material to form a finished product.

2. The method of manufacturing an adhesive material to be printed and repeatedly stuck and torn according to claim 1, wherein a TPU (Thermoplastic Polyurethane) is formed in the first mixing step.

3. The method of manufacturing an adhesive material to be printed and repeatedly stuck and torn according to claim 1, wherein a protective material is formed in the second mixing step.

4. The method of manufacturing an adhesive material to be printed and repeatedly stuck and torn according to claim 1, wherein a release paper is pasted on the adhesive layer; and
after the pasting, the release paper is torn down from the adhesive layer.

5. The method of manufacturing an adhesive material to be printed and repeatedly stuck and torn according to claim 1, wherein a coloring material is added in the second mixing step.

6. (canceled)

7. (canceled)

8. (canceled)

9. (canceled)
